(19) United States
(12) Patent Application Publication
(10) Pub. No.: US 2015/0118457 A1
(43) Pub. Date: Apr. 30, 2015

(54) METHODS FOR PATTERNING COATINGS

(71) Applicant: 3M INNOVATIVE PROPERTIES COMPANY, ST. Paul, MN (US)

(72) Inventors: Ranjith Divigalpitiya, London (CA); Mikhail L. Pekurovsky, Bloomington, MN (US); Shawn C. Dodds, St. Paul, MN (US)

(21) Appl. No.: 14/407,480

(22) PCT Filed: Jun. 10, 2013
(86) PCT No.: PCT/US2013/044921

§ 371 Date: Dec. 12, 2014

Related U.S. Application Data
(60) Provisional application No. 61/663,097, filed on Jun. 22, 2012.

(51) Int. Cl. B05D 1/32; G06F 3/044; H01B 13/00

(52) U.S. Cl. CPC B05D 1/327; H01B 13/0036; G06F 3/044; G06F 2203/04103
USPC 428/206; 427/282; 427/98.4; 428/195.1

(57) ABSTRACT

A method of forming an article is provided. The method can include providing a substrate comprising a surface. The method can further include forming a solvent soluble layer on or over the surface of the substrate in a pattern, the pattern defining one or more first portions of the surface that are overlaid by the solvent soluble layer, and one or more second portions of the surface that are free of the solvent soluble layer. The method can further include forming a second layer on or over at least one of the first portions and at least one of the second portions, wherein the step of forming the second layer includes buffing an exfoliatable material on or over at least one of the first portions and at least one of the second portions. The method can further include removing the solvent soluble layer by applying a solvent to the substrate.

### CROSS REFERENCE TO RELATED APPLICATIONS

This application claims the benefit of U.S. Provisional Application No. 61/663,097, filed Jun. 22, 2012, the disclosure of which is incorporated by reference herein in its entirety.

### TECHNICAL FIELD The present disclosure relates to methods of for patterning carbon coatings, and articles bearing such patterned carbon coatings.

### BACKGROUND

Various methods for patterning graphene or graphene-like coatings are known. For example, such methods are described in Paolo Sessi, Jeffrey R. Guest, Matthias Bode and Nathan P. Guisinger, Nano Lett., Patterning Graphene at the Nanometer Scale via Hydrogen Desorption, 2009, 9 (12), pp 4343-4347; Alexander Sinitskii and James M. Tour, J. Am. Chem. Soc., Patterning Graphene through the Self-Assembled Templates: Toward Periodic Two-Dimensional Graphene Nanostructures with Semiconductor Properties, 2010, 132 (42), pp 14730-14732; and Laura J. Cote, Rodolfo Cruz-Silva and Jiaxing Huang, J. Am. Chem. Soc., Flash Reduction and Patterning of Graphite Oxide and Its Polymer Composite, 2009, 131 (31), pp 11027-11032.

### SUMMARY

Some aspects of the present disclosure provide a method of forming an article. The method can include providing a substrate comprising a surface. The method can further include forming a solvent soluble layer on or over the surface of the substrate in a pattern, the pattern defining one or more first portions of the surface that are overlaid by the solvent soluble layer, and one or more second portions of the surface that are free of the solvent soluble layer. The method can further include forming a second layer on or over at least one of the first portions and at least one of the second portions, wherein the step of forming the second layer comprises buffing an exfoliatable material on or over at least one of the first portions and at least one of the second portions. The method can further include removing the solvent soluble layer by applying a solvent to the substrate, and thereby forming a patterned layer.

Some aspects of the present disclosure another method of forming an article. The method can include providing a substrate comprising a surface. The method can further include forming a solvent soluble layer on or over the surface of the substrate in a pattern, the pattern defining one or more first portions of the surface that are overlaid by the solvent soluble layer, and one or more second portions of the surface that are free of the solvent soluble layer. The method can further include forming a carbon layer on or over at least one of the first portions and at least one of the second portions, wherein the step of forming the carbon layer comprises buffing a conductive carbon material on or over at least one of the first portions and at least one of the second portions. The method can further include removing the solvent soluble layer by applying a solvent to the substrate, and thereby forming a patterned carbon layer.

The above summary of the present disclosure is not intended to describe each embodiment of the present invention. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIGS. 1a and 1b illustrate schematic plan and schematic side- or cross-sectional views, respectively, of an article that includes a substrate bearing a patterned carbon layer on a surface thereof in accordance with some embodiments of the present disclosure;

FIG. 2 is a scanning tunneling microscope image of a carbon layer formed in accordance with some embodiments of the present disclosure;

FIGS. 3a-3b illustrate schematic plan and schematic side- or cross-sectional views, respectively, of a substrate bearing a patterned solvent soluble layer on a surface thereof in accordance with some embodiments of the present disclosure;

FIGS. 4a-4b illustrate schematic plan and schematic side- or cross-sectional views, respectively, of a substrate bearing a patterned solvent soluble layer and a carbon layer on a surface thereof in accordance with some embodiments of the present disclosure; and

FIGS. 5a and 5b illustrate schematic plan and schematic side- or cross-sectional views, respectively, of an article that includes a substrate bearing a patterned carbon layer on a surface thereof in accordance with some embodiments of the present disclosure.

FIGS. 6a and 6b illustrate optical micrographs of the sample of Example 3 after printing a water soluble ink pattern and after washing, respectively, at 8× magnification.

FIGS. 7a and 7b illustrate optical micrographs of the sample of Example 3 after printing a water soluble ink pattern and after washing, respectively, at 100× magnification.

### DETAILED DESCRIPTION

Graphene and other thin nano-graphitic films have extraordinary material properties. Recently, it has been demonstrated that graphene-like-carbon (GLC) can be deposited onto a substrate utilizing a relatively low cost method to provide articles having high optical transparency, electrical conductivity, high mechanical flexibility, and very high thermal conductivity.

For many applications using grapheme, GLC, or other thin nano-graphitic films, it may be desirable to pattern the film. For example, in electronic applications, it may be desirable to pattern the graphitic films to delineate a pattern of a predetermined electrode configuration or a touch sensor array.

Various lithographic methods are known for patterning coatings or films. For example, such methods often involve depositing a sacrificial photoresist layer over a coating to be patterned, followed by application of a photographic negative, or mask, of the desired pattern onto the photoresist coating and exposure to light so as to selectively polymerize parts of the photoresist coating. A developing process that includes a series of solvent washes and/or etching steps (e.g., to remove a sacrificial layer) follows and the desired pattern is formed in the undercoating.

The foregoing methods have a number of disadvantages. For example, photoresist methods are multi-step processes which are time-consuming. Additionally, such methods often employ costly solvent and etchant materials, which are corrosive and/or hazardous, thereby requiring burdensome safety precautions during use and presenting disposal problems. Moreover, use of such solvents and etchants can damage the underlying substrate materials and/or prematurely degrade patterned sacrificial layers.

Therefore, simplified, more economical, and more environmentally friendly methods for pattering carbon coatings (e.g., grapheme or GLC coatings) may be desirable.

In some embodiments, the present disclosure relates to a method of making articles that include a substrate bearing a patterned layer (e.g., a patterned carbon nanolayer) on a surface thereof. Generally, the methods of the present disclosure may involve patterning (e.g., in a pattern that is the inverse of the desired patterned layer) a sacrificial layer onto areas of a substrate that are to be left uncovered by the patterned layer, forming a second layer (e.g., a carbon layer) over the entire substrate surface area of interest, and washing the substrate to remove the sacrificial layer and portions of the second layer adhered thereto to leave the desired patterned layer. Advantageously, the methods of the present disclosure may accommodate application of a layer over a patterned sacrificial layer without disturbing the physical integrity of such sacrificial layer (and thereby affecting the quality of a patterned layer produced thereby). Further, the methods of the present disclosure may facilitate removal of the patterned sacrificial layer without degrading the layer (e.g., carbon layer) disposed thereover. Still further, the methods of the present disclosure, which may be carried out using water as a solvent, may be employed without use of corrosive or hazardous solvents, etchants, or other undesirable chemicals. Moreover, the methods of the present disclosure may be compatible with high volume manufacturing processes, e.g., processes in which flexible substrates, optionally in the form of a roll, are processed in a continuous or semi-continuous fashion at a series of stations on a film line.

The articles produced utilizing the methods of the present disclosure may have associated characteristics that render them particularly suitable for many electronic applications requiring patterned, visibly transparent electrical conductors (e.g., patterned transparent conductors for touch sensitive overlays). For example, in embodiments in which the patterned layer is a patterned carbon layer, the patterned layers of the present disclosure can be tailored to provide articles with high optical transmission (e.g., a transmission over visible wavelengths of at least 80%) in combination with high electrical conductivity (e.g., sheet resistances of less than 10⁴ ohms/square).

As used herein, “carbon nanolayer” refers to a layer of carbonaceous material having an average thickness of less than about 1000 nanometers.

As used herein, “exfoliatable material” refers to materials (e.g., particles) that break up into flakes, scales, sheets, or layers upon application of shear force.

As used herein, “graphitic carbon platelet” refers to a graphitic carbon material having a first order laser Raman spectrum that exhibits two absorption bands including a sharp, intense band (G peak) centered at about 1570-1580 cm⁻¹, and a broader, weak band (D peak) centered at about 1320-1360 cm⁻¹.

As used herein, “nano-crystalline graphite” refers to a graphitic carbon material having a first order laser Raman spectrum that exhibits two absorption bands including a pair of weak bands (G peaks) centered at about 1591 cm⁻¹ and 1619 cm⁻¹, respectively, and a sharp, intense band (D peak) centered at about 1320-1360 cm⁻¹.

As used in this specification and the appended embodiments, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used in this specification, the recitation of numerical ranges by endpoints includes all numbers and ranges subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

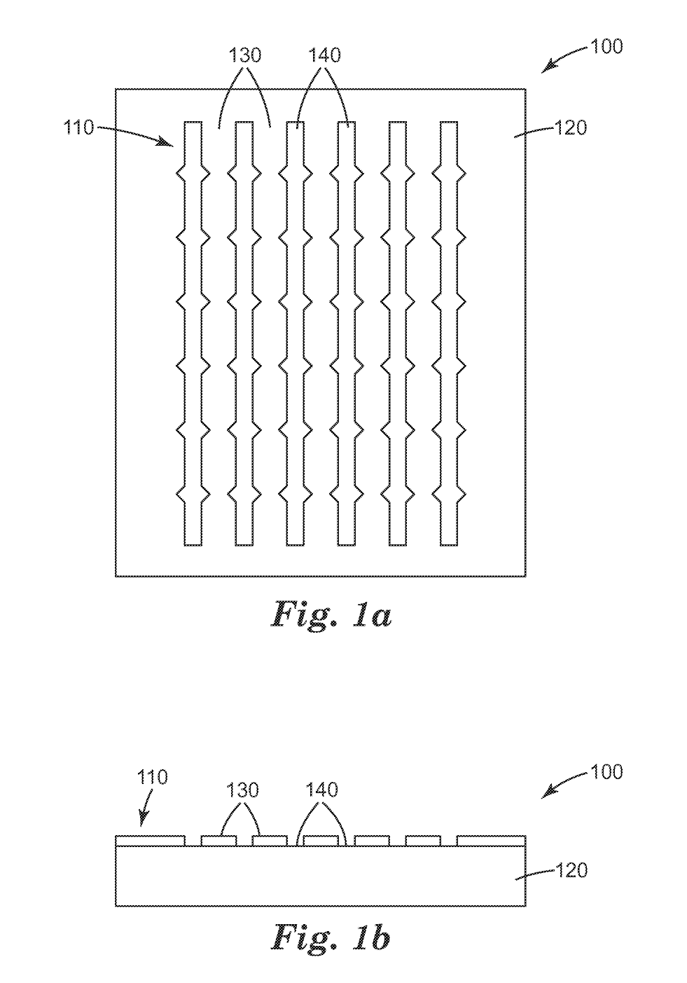

In some embodiments, the present disclosure provides articles that include a substrate bearing a patterned layer (e.g., carbon layer) on one or more surfaces (e.g., major surfaces) thereof. FIGS. 1a and 1b illustrate a schematic plan view and a schematic side- or cross-sectional view, respectively, of an article 100 that includes a patterned layer 110 arranged on a substrate 120. The patterned layer 110 defines areas 130 covered by the patterned layer 110 and areas 140 exposed or uncovered by the patterned layer 110.

In various embodiments, the substrate may be rigid or flexible. The substrate may have at least a sufficient mechanical integrity to be self-supporting. The substrate may consist essentially of only one layer of material, or it may have a multilayered construction. The substrate may have any shape and thickness.

In some embodiments, the substrate may be a plastic substrate from among polyolefins, e.g. polypropylene (PP), various polyesters, e.g. polyethylene terephthalate (PET), polymethylmethacrylate (PMMA) and other polymers such as polyethylene naphthalate (PEN), polyethersulphone (PES), polycarbonate (PC), polyetherimide (PEI), polyarylate (PAR), polyimide (PI), polyurethane (PU), polysilicones, or combinations thereof. Alternatively, the substrate may be a metal (e.g., Al, Cu, Ni, Ag, Au, Ti, and/or Cr), metal oxide, glass, composite, paper, fabric, non woven, or combinations thereof. In various embodiments, the substrate may include a transparent polymeric film such as PET or PEN.

In illustrative embodiments, the patterned layer may be may be formed from or include any exfoliatable material (e.g., exfoliatable particles). In some embodiments, the patterned layer may be formed from or include any form or type of elemental carbon. Exemplary carbons useful in the carbon layer include conductive carbons such as graphite, carbon black, lamp black, or other conductive carbon materials known to those of skill in the art. In various embodiments, exfoliatable carbon particles may be used to form the patterned layer. An example of useful exfoliatable carbon particles is HSAG300 graphite particles, available from Timcal Graphite and Carbon, Bodio, Switzerland. Other useful materials include but are not limited to SUPER P and ENSACO (Timcal), and M850 available from Asbury Carbon, Asbury, N.J. The carbon particles may also include carbon nanotubes, including multi-walled carbon nanotubes. In some embodiments, the carbon particles used to form the patterned layer may have a Mohs' hardness between 0.4 and 3.0, and may a largest dimension of less than about 100 microns. In some embodiments, the patterned layer may include additional components such as polymeric microspheres and/or other microspheres. While the present disclosure is described primarily with respect to embodiments employing patterned carbon layers, it is to be appreciated that the articles of the present disclosure could alternatively, or additionally, include patterned layers formed from other exfoliatable materials such as MoS₂ (molybdenum disulfide), WS₂ (tungsten disulfide), clays, and h-BN(hexagonal boron nitride), polytetrafluoroethylene (PTFE), sulfur, and combinations thereof. In this manner, the methods of the present disclosure accommodate patterning of semiconducting, semi-metallic, and insulating coatings.

As will be discussed in greater detail below, in various embodiments, the patterned layer may be formed on the substrate by application of a dry composition that includes carbon particles. For purposes of the present disclosure, “dry” means free or substantially free of liquid. Thus, the dry composition which forms the patterned carbon layer may be provided in a solid particulate form, rather than in a liquid or paste form.

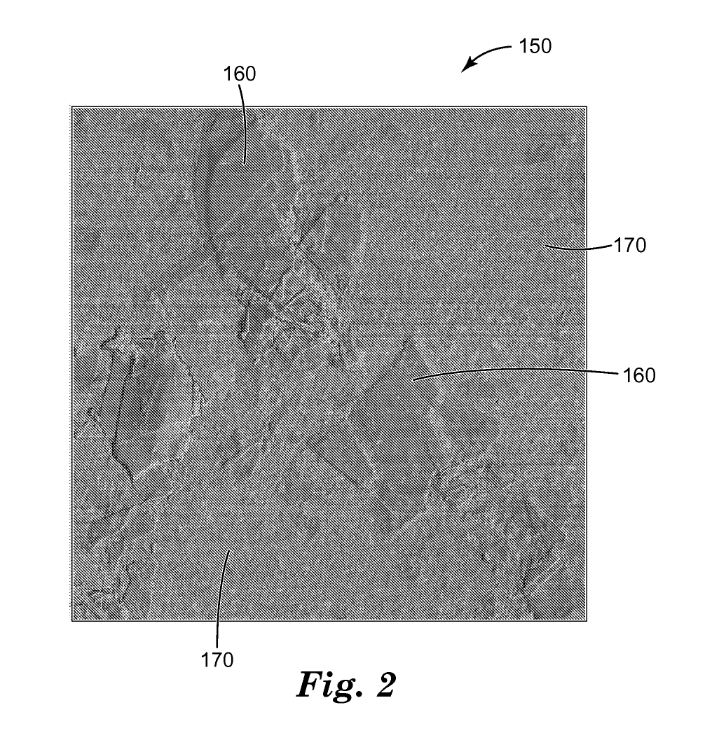

In various embodiments employing patterned carbon layers, as a result of the application methods disclosed herein, the patterned carbon layer may have a characteristic morphology that is distinct from single layer graphene on the one hand, and from nano-crystalline graphite on the other hand. FIG. 2 is a scanning tunneling microscope (STM) image 150 of a patterned carbon layer in accordance with some embodiments of the present disclosure. The scale of the image is such that the length of each side of the square-shaped image is 6 micrometers. The image reveals a morphology in which graphitic carbon platelets 160 are embedded in nano-crystalline graphite 170.

In some embodiments, the patterned layer may be formed on or over the substrate at an average thickness of less than 500 microns, less than 100 microns, less than 3 microns, less than 1000 nanometers, less than 200 nanometers, or even less than 50 nanometers. In some embodiments, the patterned layer may be formed on or over the substrate at an average thickness in a range of from 25 nanometers to 3 microns, from 50 nanometers to 1000 nanometers, or from 100 nanometers to 500 nanometers. In various embodiments, the patterned layer may be a carbon nanolayer which is formed on the substrate at an average thickness of less than 1000 nanometers, less than 200 nanometers, less than 50 nanometers, less than 10 nanometers, or even less than 1 nanometer. In illustrative embodiments, the patterned layer may have a uniform thickness. For purposes of the present disclosure, “uniform thickness” means having a relatively consistent thickness of coating over the desired dimension of the article in the plane of the substrate. The uniformity of the layer may be evaluated, for example, by optical evaluation using an optical densitometer. To evaluate uniformity, a transmission reading (or, alternatively, reflectance) is taken at six points and compared to determine the variation. In some embodiments, the variation in thickness of the patterned carbon layer is no more than 10%, no more than 5%, or no more than 3%. The wavelength to be evaluated is dependent on the physical properties of the layer and of the substrate and is appropriately selected to accurately assess the uniformity of the coating. For example, a coating that is visible under ordinary light conditions may be evaluated using a wavelength of light in the visible range, such as 550 nm, the generally accepted midpoint of visible light.

Referring again to FIG. 1, the patterned layer may be formed on the substrate in a pattern 110 (e.g., a conductive pattern) that defines areas 130 covered by the layer 110 and areas 140 exposed by the layer 110. Generally, the pattern 110 can be provided as spaced apart stripes, lines, pads, grids and the like. For example, as shown in FIG. 1, the pattern 110 may include a series of shapes (e.g., polygons, circles) joined by relatively narrow traces, but can be provided in any suitable configuration such as bars (uniform or non-uniform width) and/or an array of polygons, round shapes (e.g., circles ovals, etc.). Alternatively, or additionally, the pattern 110 may include one or more regions with two dimensional meshes, e.g. square grids, rectangular (non-square) grids, or regular hexagonal networks, where pattern features (e.g., lines) define enclosed open areas, or cells, within the mesh. Other useful geometries for mesh cells may include random cell shapes and irregular polygons.

The pattern 110 can be described with reference to the total surface area of a substrate surface covered by the carbon layer pattern 110, or pattern covered surface area. In some embodiments, the pattern covered surface area may be at least 50%, at least 30%, at least 10%, at least 5%, or at least 1%. The remainder of the substrate surface is the total unpatterned surface area.

In some embodiment, the width of the features (e.g., lines) that comprise the pattern can vary depending on the pattern selection. For example, the patterned feature, (e.g., line width) may be less than 5000 microns, less than 500 microns, less than 50 microns, less than 25 microns, less than 10 microns, less than 5 microns, or even less than 1 micron. In some embodiments, the patterned feature (e.g. line width) ranges from 1 to 500 microns, 1 to 100 microns, or 1 to 50 microns. In illustrative embodiments, the spacing between features may be less then less than 5 mm, less than 1 mm, less than 100 microns, less than 50 microns, or even less than 10 microns. The spacing between features may be in a range of from 10 microns to 5 mm, from 10 microns to 100 microns, or from 10 microns to 50 microns.

In various embodiments, the patterned layer of the present disclosure may be a carbon layer formed as described in U.S. Pat. No. 6,511,701, which is incorporated herein by reference in its entirety.

In various embodiments, the articles of the present disclosure may include one or more additional layers or materials (in addition to the patterned layer) formed on the one or more surfaces of the substrate bearing the patterned layer. For example, an overlayer may be disposed on the substrate such that the patterned layer is between the overlayer and the substrate. Additionally or alternatively, the articles may include one or more filler materials and/or adhesive materials. Suitable overlayers, filler materials, and adhesive materials include metal oxides, coatable organic materials, optical adhesives, and the like. Additionally, or alternatively, the articles may include one or more hard coat layers, one or more anti-reflective layers, and or one or more insulative layers. In various constructions according to the present disclosure, the substrate, optional overlayer, optional filler material, optional adhesive, other optional layers, and the like are transparent or substantially transparent in the visible spectrum.

In illustrative embodiments, the articles of the present disclosure, which may include a patterned layer disposed on or over a surface of a substrate, may exhibit properties that render the articles suitable for use in electronic applications. For example, the articles may useful as sensing elements for capacitive and/or inductive touch screens, particularly touch screens that are transmissive of visible light so than an image can be viewed through the touch screen. In this regard, the articles of the present disclosure may be transparent or substantially transparent, and the patterned carbon layer may provide the article with electrical conductivity.

In some embodiments, the articles of the present disclosure may have relatively high transmittance over visible wavelengths. For example, the percent transmission of the articles may be at least 30, at least 50, at least 60, at least 70, at least 80 or even at least 90% at 550 nm or over the visible wavelength range (400-700 nanometers).

In illustrative embodiments employing carbon patterned layers, the carbon patterned layer may provide the articles of the present disclosure with electrically conductivity. For example, the patterned carbon layer may provide the articles with a sheet resistance of no more than 10⁵ ohms/square, no more than 10⁴ ohms/square, no more than 10³ ohms/square, or even no more than 10² ohms/square.

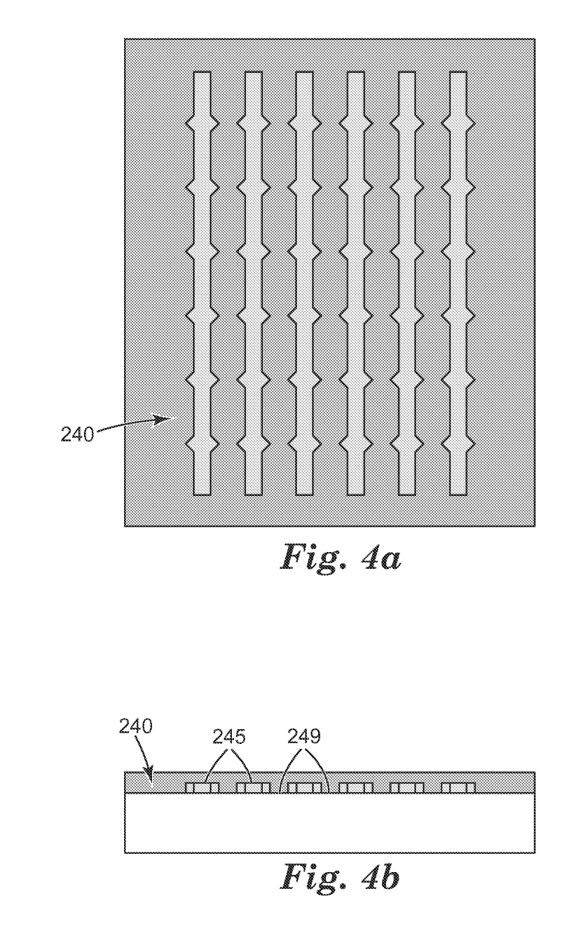

The present disclosure further relates to methods for forming the above-discussed articles. Referring to FIGS. 2a-4b, the methods may include depositing on or over a surface 210 of a substrate 220 a solvent soluble layer 230 in a desired pattern. The method may then include depositing a second layer 240 over the major surface 210 such that the second layer overlays at least a portion of the patterned solvent soluble layer 230. The method may further include applying a solvent to the major surface 210 to remove at least a portion of the solvent soluble layer 230, thereby forming a patterned layer 240′. It is to be appreciated that the methods of the present disclosure may accommodate carrying out any of the foregoing operations while the substrate is stationary or, alternatively, while the substrate is being conveyed by a suitable conveying apparatus (e.g., a moving web of the substrate).

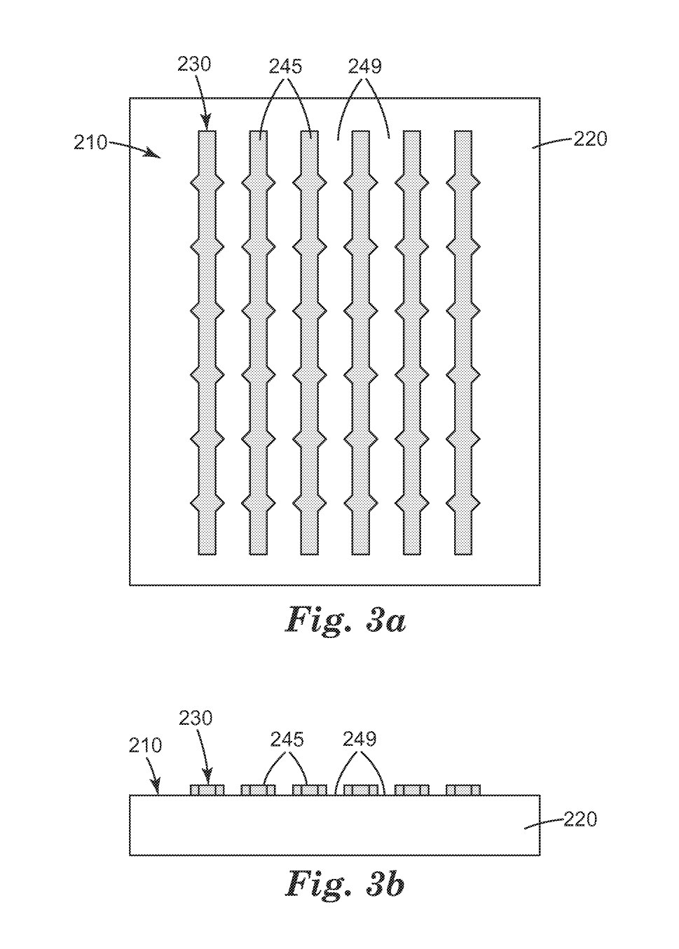

In some embodiments, the methods of the present disclosure may include forming a patterned solvent soluble layer on or over one or more surfaces of a substrate (e.g., a major surface). For example, referring again to FIGS. 3a-3b, a solvent soluble layer 230 may be formed in a pattern on a surface 210 such that one or more first portions 245 of the surface 210 are overlaid by the solvent soluble layer 230, and one or more second portions 249 are free of the solvent soluble layer 230. In various embodiments, the solvent soluble layer 230 may be formed in a pattern that is the inverse of a desired patterned layer. In this regard, as with the patterned layer discussed above, the solvent soluble layer 230 can be provided as spaced apart stripes, lines, pads, grids and the like. Alternatively, or additionally, the patterned solvent soluble layer 230 can be provided as a two dimensional mesh, such as described above with respect to the patterned carbon layer.

Generally, the solvent soluble layers of the present disclosure may be formulated so as to be rapidly removable by washing with an appropriate solvent. In this manner, the methods of the present disclosure may accommodate formation of patterned layers in a process which can be run at high speeds. In some embodiments, the solvent soluble layers may be water soluble. In various embodiments, the solvent soluble layers may include a water soluble ink. For example, the solvent soluble layer may include a water soluble ink formulated as a combination a water-soluble film-forming polymer, a solubility accelerator, and solid particulates that are insoluble in the film-former, such as described in U.S. Pat. No. 4,895,630. As an alternative, or in addition to water soluble inks, the solvent soluble layers may include polyvinyl alcohol (PVA) or poly(methyl methacrylate) (PMMA).

In various embodiments, the solvent soluble layers may be formed on the substrate using any method or apparatus suitable for depositing the materials that comprise the solvent soluble layer. For example, suitable deposition methods for the solvent soluble layers of the present disclosure may include screen, flexographic, letterpress, gravure, pad, lithographic, offset, electrophotographic, or inkjet printing. The deposition of the solvent soluble layers may be carried either in a roll-to-roll process, or on a part-by-part basis.

In illustrative embodiments, the solvent soluble layers may be formed on the substrate at an average thickness of at least 50 nm, at least 100 nm, at least 500 nm, at least 1 micron, at least 2.5 microns, or even at least 5 microns. In some embodiments, the solvent soluble layers may be formed on the substrate at an average thickness in a range of from 50 nanometers to 3 microns or from 100 nanometers to 2.5 microns.

In some embodiments, the methods of the present disclosure may further include forming a second layer on a surface (e.g., a major surface) of a substrate bearing a patterned solvent soluble layer. The second layer may be formed on the unpatterned portions (i.e., portions free of the patterned solvent soluble layer) of the substrate directly (i.e., onto a bare, uncoated substrate) or indirectly (i.e., onto one or more coatings disposed on the substrate). Similarly, the second layer may be formed on the patterned portions (i.e., portions covered by the solvent soluble layer) directly (i.e., onto a bare, uncoated solvent soluble layer) and/or indirectly (i.e., onto one or more coatings or layers disposed on the solvent soluble layers). Referring still to FIGS. 3a-5b, in illustrative embodiments, a second layer 240 may be formed on the substrate such that the second layer overlays both the first portions 245 and the second portions 249 of the substrate 210. Alternatively, the second layer 240 may overlay only one or more segments of the first portions 245 and/or the second portions 249.

In some embodiments, forming the second layer may include buffing an amount of an exfoliatable material (e.g., an exfoliatable conductive carbon material, as described above) onto a surface of the substrate. As used herein, “buffing” refers to any operation in which a pressure normal to a subject surface (e.g., a major surface of a substrate) coupled with movement (e.g., rotational, lateral, combinations thereof) in a plane parallel to said subject surface is applied. In illustrative embodiments, the exfoliatable material may be applied as a dry composition that includes particles and optionally additional components such as polymeric microspheres and/or other microspheres. Thus, the composition to be applied is provided in a solid particulate form, rather than in a liquid or paste form. In embodiments employing carbon particles, the carbon particles can be any form or type of carbon. Exemplary carbons include conductive carbons such as graphite, carbon black, lamp black, or other conductive carbon materials. An example of useful exfoliatable carbon particles is HSAG300 graphite particles, available from Timcal Graphite and Carbon, Bodio, Switzerland. Other useful materials include but are not limited to SUPER P and ENSACO (Timcal), and M850 available from Asbury Carbon, Asbury, N.J. The carbon particles can also be or comprise carbon nanotubes, including multi-walled carbon nanotubes. The carbon particles may have a Mohs' hardness between 0.4 and 3.0 and a largest dimension of less than about 100 microns.

Buffing of the second layer may be carried out using any buffing apparatus known in the art (e.g., power sander, power buffer, orbital sander, random orbital sander) suitable for applying dry particles to a surface, or manually (i.e., by hand). An exemplary buffing apparatus may include a motorized buffing applicator (e.g., disc, wheel) which may be configured to apply a pressure normal to a subject surface as well as rotate in a plane parallel to said subject surface. The buffing applicator may include a buffing surface that contacts with, or is intended to contact with, the subject surface during a buffing operation. In some embodiments, the buffing surface may include metal, polymer, glass, foam (e.g., closed-cell foam), cloth, paper, rubber, or combinations thereof. In various embodiments, the buffing surface may include an applicator pad that may be made of any appropriate material for applying particles to a surface. The applicator pad may, for example, be made of woven or non-woven fabric or cellulosic material. The applicator pad may alternatively be made of a closed cell or open cell foam material. In other cases, the applicator pad may be made of brushes or an array of nylon or polyurethane bristles. Whether the applicator pad comprises bristles, fabric, foam, and/or other structures, it may have a topography wherein particles of the composition to be applied can become lodged in and carried by the applicator pad.

In some embodiments, the buffing applicator may be configured to move in a pattern parallel to the subject surface and to rotate about a rotational axis perpendicular to the subject surface. The pattern may include a simple orbital motion or random orbital motion. Rotation of the buffing applicator may be carried out as high as 100 orbits per minute, as high as 1,000 orbits per minute, or even as high as 10,000 orbits per minute. The buffing applicator may be applied in a direction normal to the subject surface at a pressure of a least 0.1 g/cm², at least 1 g/cm², at least 10 g/cm², at least 20 g/cm², or even at least 30 g/cm².

The second layer can be formed on or over a surface of the substrate in a number of ways. In one approach, the composition used to form the second layer can first be applied directly to the surface, and then the buffing applicator may contact the composition and the surface. In another approach, the composition can first be applied to the buffing surface of the buffing apparatus, and the particle-loaded buffing surface may then contact the surface of the substrate. In still another approach, a portion of the composition can be applied directly to the surface, and another portion of the composition can be applied to the buffing surface of the buffing apparatus, after which the particle-loaded buffing surface may contact the surface and remainder of the composition.

In some embodiments, the buffing operation of the present disclosure can be used to produce a high quality, thin layer (e.g., a carbon nanolayer) on or over a surface of a substrate. The thickness of the buffed layer may be controlled by controlling the buffing time. Generally, the thickness of the coating may increase linearly with buffing time after a certain rapid initial increase. The coating thickness of the second layer may also be controlled by controlling the amount of the composition used during the buffing operation.

The buffing described herein may be used to produce high quality, low cost layers of carbon that are uniform in thickness, of high transparency, and of adequate sheet resistance. Additionally, as previously discussed, the carbon layers produced by the buff coating process of the present disclosure may have a characteristic morphology that is distinct from single layer graphene on the one hand, and from nano-crystalline graphite on the other hand. For example, the carbon layers of the present disclosure may have a morphology in which graphitic carbon platelets are embedded in nano-crystalline graphite.

In various embodiments, the buffing process described herein may form a second layer on all exposed surfaces of the substrate and the patterned solvent soluble layer, such that the second layer substantially conforms to the unpatterned portions of the substrate and the top and side surfaces of the features of the solvent soluble layer. Moreover, such a conforming second layer may be formed without damaging the solvent soluble layer (e.g., altering pattern features). In this regard, surprisingly, it was discovered that the buffing methods of the present disclosure, which may involve rapid and repeated motion of a buffing applicator pad that contains bristles, fabric, and/or other surface structures that are large compared to the thickness of the solvent soluble layer, do not abrade or damage the solvent soluble layer. Thus, the physical integrity of the sacrificial solvent soluble layer is substantially maintained throughout the carbon layer formation process, and may result in patterned layers exhibiting sharp edge definition.

In illustrative embodiments, adherence of the second layer to the substrate may be assisted by heating the substrate prior to, during, or after the buffing operation to a temperature such that the adhesion of the layer is enhanced. Exemplary methods of heat input to the substrate may include oven heating, heat lamp heating (e.g., infrared), or a heated platen in contact with the substrate.

In various embodiments, the second layer may be deposited onto the substrate in accordance with the methods described in U.S. Pat. No. 6,511,701.

In some embodiments, following formation of the second layer, the methods of the present disclosure may include removing the solvent soluble layer from the substrate to form a patterned layer. Generally, removal of the solvent soluble layer may include application of a solvent to the substrate such that the solvent soluble layer is dissolved or otherwise removed from the substrate by the solvent. Application of the solvent may include any or all of solvent immersion, rinsing, washing, spraying, brushing or the like. Application of the solvent may be enhanced by any or all of agitating, rocking, shaking, stirring or the like of either or both of the substrate and the solvent. In various embodiments, the foregoing removal processes, in addition to removing the solvent soluble layer, may also remove portions of the second layer that adhere to the solvent soluble layer during removal. Surprisingly and advantageously, it was discovered that the solvent removal processes of the present disclosure do not damage or degrade the patterned layer. That is, following removal of the solvent soluble layers and any portions of the second layer adhering thereto, the resulting patterned layer is of high quality and exhibits excellent edge definition.

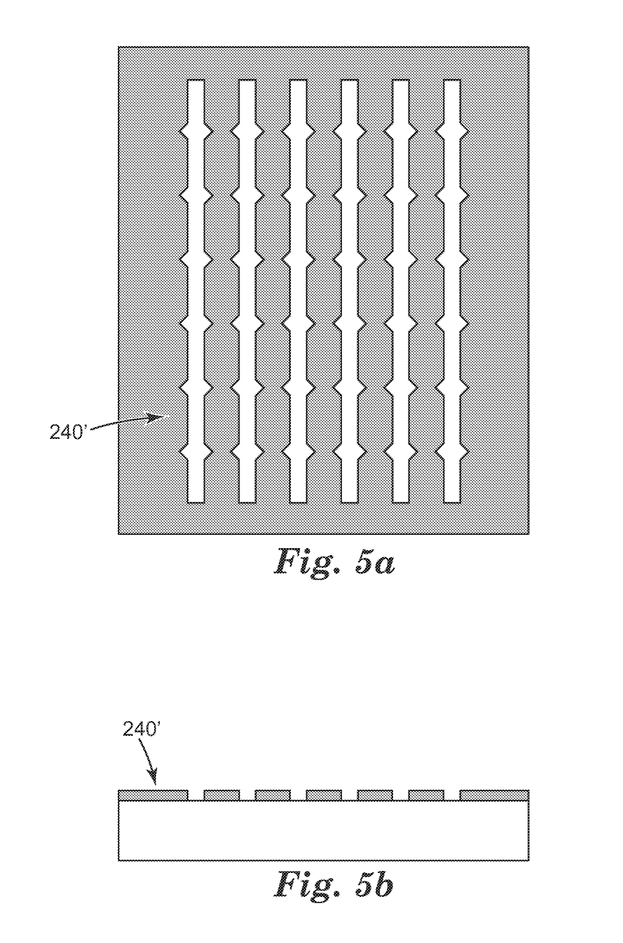

FIGS. 5a-5b illustrate schematic plan and schematic side views, respectively, of the substrate 220 after the solvent soluble layer 230 and portions of the second layer 240 adhering thereto have been removed from the substrate 220. As shown, a layer pattern 240′, which is approximately an inverse of patterned features formed by the sacrificial solvent soluble layer 230, may be formed on the surface 210 of the substrate 220.

The articles of the present disclosure, in embodiments in which the second layer is a carbon layer, may be employed, for example, as touch sensitive overlays that utilize a patterned transparent conductor as the sensing element(s). These include discrete matrix touch sensors (such as disclosed in U.S. Pat. Nos. 6,813,957; 6,762,752; 6,188,391; 5,844,506; 5,386,219; and 5,007,085, as well as International Publications WO 01/27868, WO 01/100074, and WO 01/52416), discrete bar sensors (such as disclosed in U.S. Pat. No. 5,650,597 and U.S. Patent Publication 2003/0103043), discrete pad sensors (such as disclosed in U.S. Pat. No. 4,789,767), and other discrete sensing element sensors, as well as electrically continuous patterned sensing layer sensors (such as disclosed in U.S. Pat. No. 4,198,539). These types of sensors can be advantageously used in capacitive, projected capacitive, and/or inductive sensing technologies, and can be used in a variety of applications that benefit from on-screen input including hand-held devices (e.g., palm top computers, personal organizers, mobile phones, music players, etc.), tablet computers, automotive navigation system displays, touch input monitors, public information kiosks, automated teller machines, gaming and entertainment devices, and so forth.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

### Example 1

A water soluble ink pattern was printed on the surface of a 75 micrometer thick PET substrate (Melinex® Polyester Film 393 obtained from Cadillac Plastics, Inc., Toronto, Canada) film using standard flexographic techniques at a speed of 20 feet/minute (about 6.1 meters/minute). The stamp which was made of a rubber and mounted on a roller contained (1-5 millimeter) sized features and gaps. The water soluble ink had a viscosity of roughly 250 cP, and was of a composition as generally described in U.S. Pat. No. 4,895,630.

After the water soluble ink pattern was printed, an 8 inch by 11 inch (about 20.3 centimeters by 27.9 centimeters) section of the printed PET substrate film layer was coated with a carbon layer by buffing graphite powder (TIMREX®HSAG 300 obtained from TIMCAL Ltd., Switzerland) for about 20 seconds. Buffing of the graphite powder was accomplished using a paint pad (Shur-Line® paint pad, obtained from Shur-Line, Huntersville, N.C.) attached to an orbital finishing sander (Model BO4900V Finishing Sander, obtained from Makita USA, Inc., La Mirada, Calif.) as described generally in U.S. Pat. No. 6,511,701.

Surprisingly, buffing did not visibly disturb the ink pattern. The carbon coated article was then washed with water by gently wiping it with a paper towel. Immediately, the carbon coated areas over the water soluble ink pattern were removed, leaving carbon coated areas free of water soluble ink regions intact. This produced a patterned carbon coating on the PET substrate that had the inverse pattern of the water soluble ink coverage with extremely well defined edges. Thus, a patterned carbon coating on PET was surprisingly easily obtained.

The electrical sheet resistance of the pattern was measured with a hand held two-probe meter and found to be less than 10³ Ohm/[ ].

### Example 2

Example 2 was prepared in the same manner as Example 1 except that the PET substrate printed with the water soluble ink was buffed with graphite powder (TIMREX®HSAG 300) mixed with Magenta microspheres (MP-MG5518 obtained from Tartan Color & Chemicals, Ontario, Canada) at a 15:85 weight ratio.

As was the case in Example 1, buffing did not visibly disturb the water soluble ink pattern. The feature width of the resulting pattern ranged from 1 millimeter to 5 millimeters.

The electrical sheet resistance of the pattern was measured with a hand held two-probe meter and found to be about 10⁴ Ohm/[ ].

### Example 3

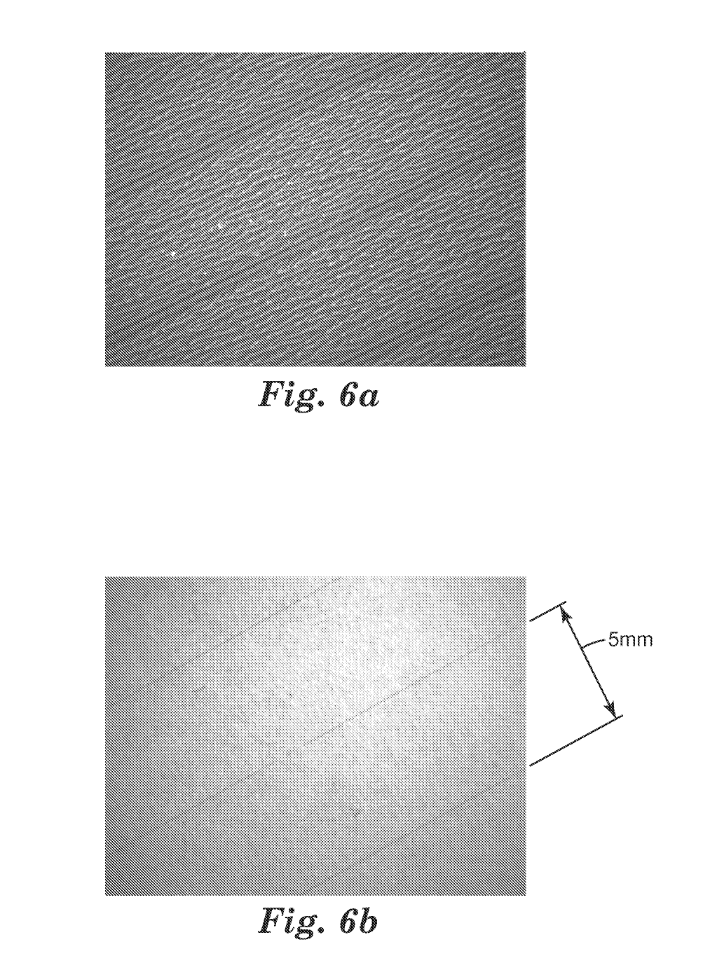

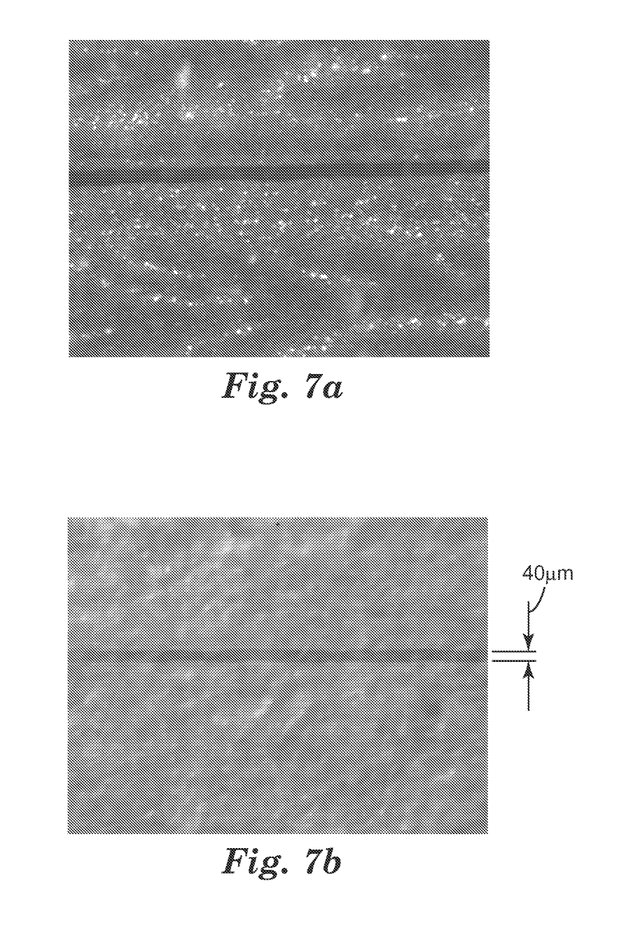

Example 3 was prepared in the same manner as Example 2 except that the water soluble ink pattern was printed with feature spacing of about 5 mm and a feature width of about 40 microns. After buffing, the carbon coated article was washed with water to reveal the patterned carbon coating. Optical micrographs of the samples after printing the water soluble ink pattern and after washing, at 8× magnification, are shown in FIGS. 6A and 6B, respectively. Optical micrographs of the samples after printing the water soluble ink pattern and after washing, at 100× magnification, are shown in FIGS. 7A and 7B, respectively. It was observed that the quality of the patterned carbon coatings followed closely with that of the water soluble ink patterns.

### Example 4

The procedure of example 1 was repeated except that molybdenum disulfide powder (MoS₂, 6 micron average particle size, obtained from Rose Mill, Hartford, Conn.) was buffed onto the PET substrate instead of graphite powder. After coating the printed ink pattern with MoS₂ powder, a very uniform MoS₂ layer was observed. After washing with water, the coated PET yielded patterned MoS₂ lines about 40 microns wide.

### Example 5

The procedure of example 1 was repeated except that hexagonal boron nitride powder (h-BN, 5 micron average particle size, obtained from M.K. Impex Corporation, Mississauga, Canada) was buffed onto the PET substrate instead of graphite powder. After washing with water, the coated PET yielded patterned h-BN traces about 40 microns wide.

1. A method of forming an article comprising:
providing a substrate comprising a surface;
forming a solvent soluble layer on or over the surface of the substrate in a pattern, the pattern defining one or more first portions of the surface that are overlaid by the solvent soluble layer, and one or more second portions of the surface that are free of the solvent soluble layer;
forming a second layer on or over at least one of the first portions and at least one of the second portions, wherein the step of forming the second layer comprises buffing an exfoliatable material on or over at least one of the first portions and at least one of the second portions; and
removing the solvent soluble layer by applying a solvent to the substrate, and thereby forming a patterned layer.

2. The method according to claim 1, wherein the exfoliatable material comprises a conductive carbon, MoS₂, WS₂, clays, h-BN(hexagonal boron nitride), PTFE, sulfur, or combinations thereof

3. The method according to any one of claims 1-2, wherein the step of forming the second layer further comprises buffing a dry composition of the exfoliatable material on or over at least one of the first portions and at least one of the second portions.

4. The method according to any one of claims 1-3, wherein the exfoliatable material comprises a conductive carbon.

5. The method according to claim 4, wherein the second layer has a morphology comprising graphite platelets embedded in amorphous carbon.

6. The method according to any one of claims 1-5, wherein the second layer has an average thickness of less than 1000 nanometers.

7. The method according to any one of claims 1-6, wherein the patterned layer provides the article with a sheet resistance of less than 10⁴ ohms/square.

8. The method according to any one of claims 1-7, wherein following the step of removing the solvent soluble layer, the article has an optical transmission of at least 80% at 550 nm.

9. The method according to any one of claims 1-8, wherein the solvent soluble layer comprises a water soluble material.

10. The method according to any one of claims 1-9, wherein the solvent soluble layer comprises a water soluble ink.

11. The method according to any one of claims 1-10, wherein the solvent soluble layer comprises a water-soluble film-forming polymer, a solubility accelerator, and solid particulates that are insoluble in the film-forming polymer.

12. The method according to any one of claims 1-11, wherein the substrate comprises a transparent polymeric film.

13. An article formed according to the method of any one of claims 1-12.

14. A method of forming an article comprising:
providing a substrate comprising a surface;
forming a solvent soluble layer on or over the surface of the substrate in a pattern, the pattern defining one or more first portions of the surface that are overlaid by the solvent soluble layer, and one or more second portions of the surface that are free of the solvent soluble layer;
forming a carbon layer on or over at least one of the first portions and at least one of the second portions, wherein the step of forming the carbon layer comprises buffing a conductive carbon material on or over at least one of the first portions and at least one of the second portions; and
removing the solvent soluble layer by applying a solvent to the substrate, and thereby forming a patterned carbon layer.
